(19) United States
(12) Patent Application Publication
(10) Pub. No.: US 2008/0120060 A1
(43) Pub. Date: May 22, 2008

(54) DETECTION OF CATALYST LOSSES IN A FLUID CATALYTIC CRACKER FOR USE IN ABNORMAL SITUATION PREVENTION

(75) Inventors: Ravi Kant, Savage, MN (US); John P. Miller, Eden Prairie, MN (US)

Correspondence Address: MARSHALL, GERSTEIN & BORUN LLP (FISHER), 233 SOUTH WACKER DRIVE, 6300 SEARS TOWER, CHICAGO, IL, 60606, US

(73) Assignee: FISHER-ROSEMOUNT SYSTEMS, INC., Austin, TX (US)

(21) Appl. No.: 11/861,985

(22) Filed: Sep. 26, 2007

Related U.S. Application Data
(60) Provisional application No. 60/848,596, filed on Sep. 29, 2006.

(51) Int. Cl. C10B 49/00; G06F 17/18; G01L 19/00; G06F 15/00

(52) U.S. Cl. 702/138; 201/1; 702/179

(57) ABSTRACT

A method and system for detecting and/or predicting abnormal levels of catalyst loss in a fluid catalytic cracking unit. The method and system measures a differential pressure across portions of a fluid catalytic cracker, such as a reactor cyclone or a regenerator cyclone, and determines abnormal catalyst loss when the differential pressure changes significantly from a baseline differential pressure. The claimed method and system implements algorithms using computing devices to detect or predict an abnormal condition based on the change in a monitored differential pressure in a fluid catalytic cracking unit.

This application claims the benefit of U.S. Provisional Patent Application Ser. No. 60/848,596, filed Sep. 29, 2006, the entirety of which is hereby incorporated by reference herein.

### FIELD OF THE INVENTION

This patent relates generally to performing diagnostics and maintenance in a process plant and, more particularly, to providing diagnostics capabilities within a process plant in a manner that reduces or prevents abnormal situations within the process plant.

### BACKGROUND

Fluid catalytic cracking is a commonly used process in modem oil refineries to crack high molecular weight oil (hydrocarbons) into lighter components including liquefied petroleum gas, gasoline, aviation fuel, and diesel. Generally, the fluid catalytic cracking process uses a catalyst to first break down the high molecular weight hydrocarbons and then uses at least one cyclone to separate the resulting mixture into collectible byproducts. The used catalytic substance may then be recycled for injection into another reaction cycle. One problem that may occur in the fluid catalytic cracking processes is that the catalyst loss from either a reactor component or a regenerator component may be too high. If left uncorrected, this catalyst loss may lead to problems in subsequent processing units downstream from a fluid catalytic cracker.

### SUMMARY

The claimed method and system detects and/or predicts abnormal rate of catalyst loss in a fluid catalytic cracking unit. A differential pressure may be monitored across portions of a fluid catalytic cracker such as a reactor cyclone or a regenerator cyclone. Significant changes to the normal differential pressure across the portions of the fluid catalytic cracking unit during operation may indicate an increase in catalyst loss, and may also indicate a malfunction in the fluid catalytic cracker or a need for maintenance. The claimed method and system implements algorithms using computing devices to detect or predict an abnormal condition based on a change in a monitored differential pressure across a fluid catalytic cracking cyclone. When an abnormal situation is detected, an alert may be generated to notify appropriate entities.

### BRIEF DESCRIPTION OF THE DRAWINGS

FIG. 1 illustrates a fluid catalytic cracking unit;

FIG. 2 illustrates a computing device that may be used to implement a statistical process monitoring (SPM) algorithm;

FIG. 3 illustrates an SPM module that may be implemented on a computing device;

FIG. 4 illustrates an embodiment of an abnormal operation detection (AOD) module using a regression model;

FIG. 5 illustrates a process flow diagram for detecting catalyst loss using a regression;

FIG. 6 illustrates an example process plant in which an abnormal situation prevention system may be implemented; and

FIG. 7 illustrates a portion of a process plant showing an abnormal situation prevention system communicating with various devices.

### DETAILED DESCRIPTION

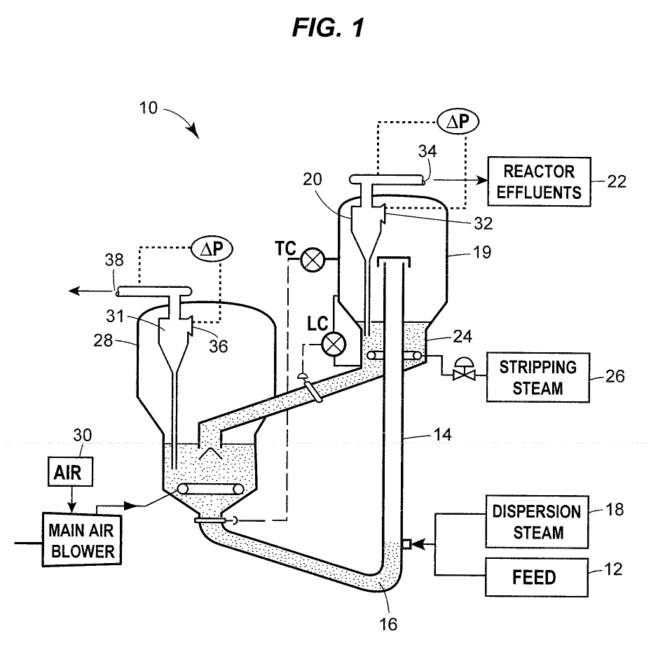

Generally, FIG. 1 illustrates a fluid catalytic cracking apparatus 10 for implementing a fluid catalytic cracking process on high molecular weight oil. A feed 12 comprising the high molecular weight oil may be fed at the bottom of a reactor 14, that is a vertical or upward sloped pipe, sometimes called a “riser.” A highly active catalyst 16 may be introduced into the riser 14 to contact the feed 12. The feed 12 may be pre-heated and sprayed into the base of the riser 14 via feed nozzles (not shown) where the feed 12 contacts extremely hot fluidized catalyst. Dispersion steam 18 may be used to spray the feed 12 through the feed nozzles. As the hot catalyst contacts the feed 12, the catalyst vaporizes the feed 12 and catalyzes the cracking reactions that break down the nigh molecular weight oil into lighter components such as liquefied petroleum gas (LPG), gasoline, and diesel. The catalyst-hydrocarbon mixture may then flow upward through the riser 14 and eventually into a disengaging vessel 19. The catalyst-hydrocarbon mixture may be collected in a reactor cyclone 20 and the hydrocarbon portion of the mixture may be separated from the catalyst via the cyclone 20. The majority of the catalyst may be output from the cyclone 20 and deposited within the disengaging vessel 19. Cyclone reactor effluents 22 comprising mostly catalyst-free hydrocarbons may be routed to a main fractionator (not shown) for further separation into fuel gas, LPG, gasoline, light cycle oils used in diesel and jet fuel, heavy fuel oil, etc.

When the cracking catalyst moves tip the riser 14, the cracking catalyst is “spent” by reactions which deposit coke on the catalyst and reduce the activity and selectivity of the catalyst. The used catalyst is disengaged from the cracked hydrocarbon vapors in the disengaging vessel 19 and is sent to a stripper 24 where the used catalyst may be contacted with stripping steam 26 to remove residual hydrocarbons remaining in the catalyst. The spent catalyst may then be directed into a fluidized-bed regenerator 28 where hot air 30 (or in some cases, air plus oxygen) is used to burn off the coke deposits to restore the catalyst to an active state and also to provide the necessary heat for the next reaction cycle. Burning the coke deposits yields flue gas which includes carbon dioxide and carbon monoxide. A regenerator cyclone 31 may be used to separate or filter flue gas from the solid catalyst and solid coke mixture of the regenerator 28. The “regenerated” catalyst may be returned to the base of the riser 14 for repeating the cycle.

A problem that may occur in the operation of the fluid catalytic cracking apparatus is loss of catalyst, which may occur along the cyclical catalyst path. While some nominal catalyst loss may be expected in a fluid catalytic cracking process, larger catalyst loss may indicate an equipment failure (e.g., a leak) or a need for maintenance and repair. In one embodiment, catalyst loss may be detected by measuring a differential pressure (ΔP) across either the reactor cyclone 20, the regenerator cyclone 31, or both, as shown in FIG. 1. For example, the differential pressure may be taken across a cyclone input 32 and an effluent output 34 of the reactor cyclone 20 or a cyclone input 36 and a flue gas output 38 of regenerator cyclone 31. In this embodiment, the differential pressure(s) may remain close to a steady value for normal operation. If the differential pressure decreases significantly from the initial (normal) state, then an abnormal increase in catalyst loss may occur. This may indicate that more than a normal amount of catalyst is escaping with the reactor effluents of the reactor cyclone or with the flue gas of the regenerator cyclone.

### Detecting Abnormal Catalyst Loss

An abnormal operation detection system as described herein may be implemented to predict or detect catalyst loss so that preventative measures may be taken to reduce the loss of catalyst in the fluid catalytic cracking unit. The abnormal operation detection system may be implemented in an existing process control system or installed as an independently functioning computing unit. Generally, the abnormal operation detection system may be implemented as hardware or software running on a computing device. The following describes various types of algorithms that may be implemented by the abnormal operation detection system to detect or predict catalyst loss in a fluid catalytic cracker.

### Statistical Process Monitoring

One algorithm that may be used for determining catalyst loss in a fluid catalytic cracking unit is a statistical process monitoring (SPM) algorithm. SPM may be used to monitor variables, such as quality variables, associated with a process, and flag an operator when the quality variable is detected to have moved from its “statistical” norm. The SPM algorithm may generally calculate the mean and standard deviation of a process variable, such as the pressure differential, over non-overlapping sampling windows.

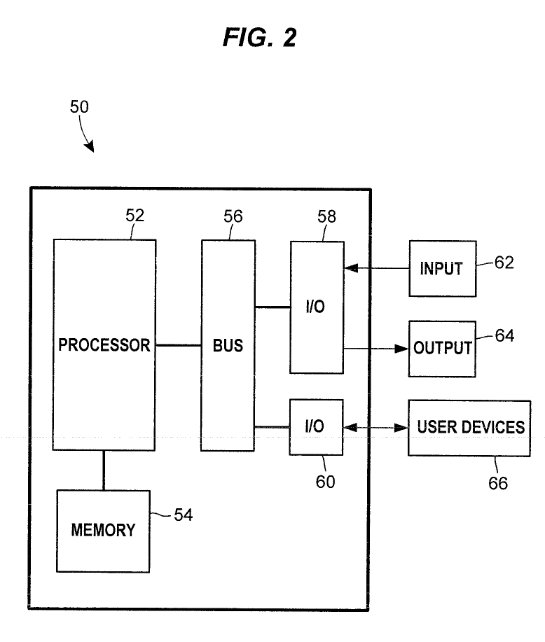

FIG. 2 illustrates a computing device that may be used to implement an SPM algorithm or SPM function block in one embodiment. Components of computing device 50 may include, but are not limited to, a processing unit 52, a system memory 54, and a system bus 56 that couples various system components to the processing unit 52. Memory 54 may be any available media that is accessible by the processing unit 52 and includes both volatile and nonvolatile media, removable and non-removable media. A user may enter commands and information into the computing device 50 through user input devices 66, such as a keyboard and a pointing device. These and other input devices may be connected to the processing unit 52 through a user input interface 60 that may be coupled to the system bus 56. A monitor or other type of display device may also be connected to the processor 52 via the user interface 60. Other interface and bus structures may also be used. In particular, inputs 62 from other devices (e.g., sensors), may be received at the computing device 50 via input/output (I/O) interface 58 and outputs 64 from computing device 120 may be provided by the input/output (I/O) interface 58 to other devices. The interfaces 58 and 60 connect various devices to the processor 52 via the system bus 56.

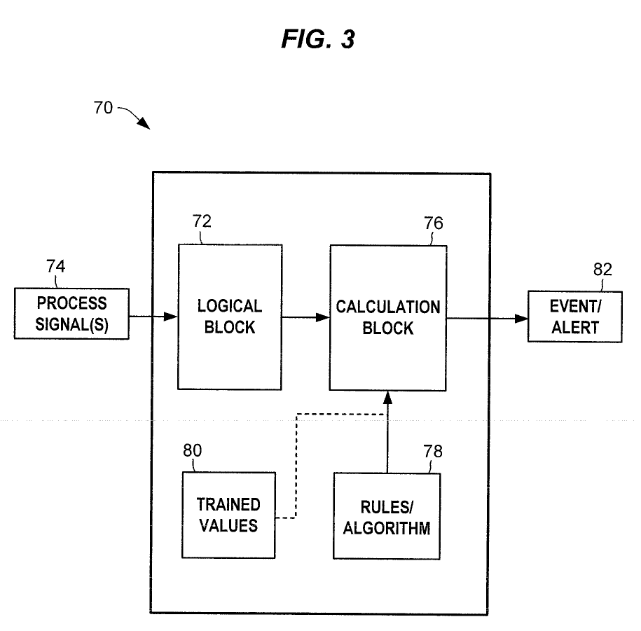

FIG. 3 illustrates a statistical process monitoring (SPM) module 70 that may be implemented on the computing device 50 of FIG. 2. A logical block 72 may receive a set of process signals 74 and may calculate statistical signatures or statistical parameters for the set of process signals 74. These statistical parameters may be calculated based on a sliding window of first process variable data or based on non-overlapping windows of first process variable data. The calculated statistical parameters or statistical signatures may include mean, standard deviation, variance (S²), root-mean-square (RMS), rate of change (ROC) and range (ΔR) of the process signal, for example. These statistical parameters may be given by the following equations:

$$mean = x = \frac{1}{N} {\sum }_{i = 1}^{N} {x}_{i}$$

S=STANDARD_DEVIATION=σ

$$\begin{matrix}VARIANCE = {( STANDARD\_DEVIATION )}^{2} \\ = {S}^{2} \\ = \frac{1}{n - 1}\end{matrix} = \frac{1}{n - 1}$$

$$RMS = \sqrt{\frac{1}{N} {\sum }_{i = 1}^{N} {X}_{i}^{2}}$$

$$ROC = {r}_{i} = \frac{{x}_{i} - {x}_{i - 1}}{T}$$

ΔR=X_{MAX}−X_{MIN}

In the equations above, N is the total number of data points in the sample period, xᵢ and xₓ₋₁ are two consecutive values of the process signal, and T is the time interval between the two values. Further, X_{MAX} and X_{MIN} are the respective maximum and minimum of the process signal over a sampling or training time period. These statistical parameters may be calculated alone or in any combination. Additionally, it will be understood that the invention includes any statistical parameter other than those explicitly set forth which may be implemented to analyze a process signal. The calculated statistical parameter(s) may be received by a calculation block 76 which operates in accordance with rules contained in a rules block 78. The rules block 78 may be implemented, for example, in a portion of the memory 54 of computing device 50 (FIG. 2) and may define an algorithm for detecting or calculating an abnormal situation, as further discussed below.

In another embodiment, the trained values may be calculated and periodically updated, for example, by the computing device 50. For example, in one embodiment, the trained values may be generated by the statistical parameter logical block 72 which generates, or learns, the nominal or normal statistical parameters during a first period of operation, typically a period during normal operation of the process. These nominal statistical parameters may then be stored as trained values in the trained values block 80 for future use (as described further below). This operation allows dynamic adjustment of trained values 80 for a specific loop and operating condition. In this situation, statistical parameters (which may be used for the trained values) may be monitored for a user selectable period of time based upon the process dynamic response time. In one embodiment, a computing device such as the computing device 50 may generate or receive the trained values or be used to transmit the trained values to another process device.

In one embodiment, the SPM block 70 illustrated in FIG. 3 may be used to implement an algorithm for detecting catalyst loss in a fluid catalytic cracker by receiving an input such as the pressure differential across a reactor or regenerator cyclone of the fluid catalytic cracker and to determine abnormal conditions. In this embodiment, the SPM block 70 may act as an abnormal operation detection (AOD) module. In this configuration, the rules block 78 may contain rules for calculating the abnormal conditions based on an inputted pressure differential across a cyclone. The calculation block 76 may be programmed to output an alert 82 when an abnormal condition is detected. Here, the observed pressure differential may be sampled at regular intervals and inputted into the SPM block 70 of FIG. 3 as a process signal 74. During a learning phase, the logical block 72 may determine a baseline mean (μ) and a baseline standard deviation (σ) of the pressure differential (ΔP). These parameters may be considered a representation of the process in a “normal” condition. The baseline mean and baseline standard deviation may then be stored in the memory 54 as training values (i.e., using block 80). During a monitoring phase, the SPM block 70, implementing the algorithm, may take current values of the pressure difference and calculate the process mean ( x̅) and standard deviation (s) over non-overlapping sampling windows with the same length as the sampling window used during the learning period.

Using the SPM algorithm via the SPM block 70, catalyst loss may be detected at the calculation block 76 if the actual or current mean differs from the baseline mean by more than some threshold and an indication or an alarm 82 may be outputted. For example, catalyst loss may be detected if the current mean is more than a certain percent below the baseline mean:

$$\overline{x} < ( 1 - \frac{α}{100} ) \cdot μ$$

where α is some user-defined percent (e.g., 5%). This equation may be represented as one or more rules in the rules block 78. In one embodiment, the SPM block 70 may include an input for a detection threshold (e.g., one determined by a user). In this embodiment, the detection threshold may be stored as a trained value.

One drawback to the above described approach may be that a user with knowledge of the process may have to determine an appropriate value for α. This requirement may be tedious and time consuming if there are many different process variables for which a threshold needs to be set.

In another embodiment, the threshold may be set based on a variance observed during the learning phase. For example, catalyst loss may be detected if x̅<μ−3σ. In this case, the observed variance may be stored in the memory 54 via the trained value block 80. Thus, in this embodiment, the detection threshold is determined automatically, and the amount of manual configuration may be reduced. It should be noted that any other multiplier for the standard deviation besides three may be used, depending on the observed or detected variance. Also, while the variance variable may be automatically calculated by the SPM module this variable may be a user-configurable parameter input as a trained variable (e.g., via user P/O 66).

### Regression and Residual Monitoring

The SPM algorithm may be appropriate for detecting catalyst losses if the pressure differential ΔP changes only when high catalyst losses occur. However, if the pressure differential ΔP changes due to other factors (e.g., when the pressure differential ΔP changes due to load changes or other expected process conditions), then the SPM algorithm may trigger false alarms. In one embodiment, more than a single set of SPM derived characteristics (e.g., mean, standard deviation, etc.) may be generated depending on the operating condition or operating state of the fluid catalytic cracking unit. For example, if there are two different loads in which the cracking unit operates, then the calculation block 76 may be programmed to implement one set of rules for a first load condition and to implement a second set of rules for a second load condition. In this embodiment, two SPM blocks may be used. Activation of one or the other SPM block may be based on a detected load condition or other expected process condition.

While multiple SPM blocks may be used for simple condition changes (e.g., when only two load possibilities exist), multiple SPM blocks may be inefficient when many expected operating conditions exist. In this case, some form of regression (e.g., developing a regression model and then monitoring the residuals) may be used to detect catalyst losses.

In general, during a learning phase, data is collected from both the cyclone pressure differential ΔP (y), and from the process variable(s) which may have some effect on the cyclone pressure differential ΔP (x₁, x₂, . . . xₘ). A model may be developed to predict the value of y as a function of the x's:

ŷ=f(x₁, x₂, . . . xₘ)

This model may be anything from a simple multiple linear regression model, e.g.,

f(x₁, x₂, . . . xₘ)=α₀α₁x₁+α₂x₂+ . . . +αₘxₘ,

with coefficients calculated according to any known method such as ordinary least squares (OLS), principal component regression (PCR), partial least squares (PLS), variable subset selection (VSS), support vector machine (SVM), etc.), to something more complicated, such as a neural network model. As discussed further below, once the model is developed during the monitoring phase, the model may be used to calculate the residual (difference between actual and predicted values). If the residual exceeds some threshold, then an abnormal situation may be detected.

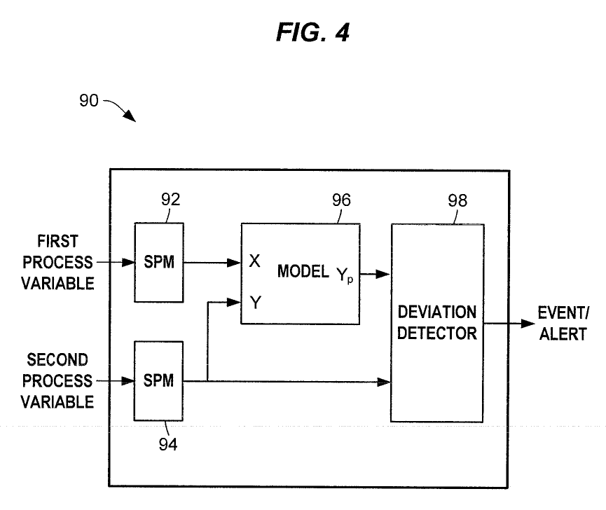

FIG. 4 illustrates an embodiment of an abnormal operation detection (AOD) module 90 that may be used to implement a regression and residual monitoring algorithm. The AOD module 90 may include a first SPM block 92 and a second SPM block 94 coupled to a model implementation block 96. The first SPM block 92 may operate similarly to the SPM module 70 illustrated in FIG. 3. As such, the first SPM block 92 receives a first process variable and generates first statistical data from the first process variable. As discussed above, this operation may include generating statistical signature data such as mean data, median data, standard deviation data, rate of change data, range data, etc., calculated from the first process variable. Such data may be calculated based on a sliding window of first process variable data or based on non-overlapping windows of first process variable data. As one example, the first SPM block 92 may generate mean data using a most recent first process variable sample and 49 previous samples of the first process variable. In this example, a mean variable value may be generated for each new first process variable sample received by the first SPM block 92. As another example, the first SPM block 92 may generate mean data using non-overlapping time periods. In this example, a window of five minutes (or some other suitable time period) may be used, and a mean variable value would thus be generated once for every five minute period. In a similar manner, the second SPM block 94 receives a second process variable and generates second statistical data from the second process variable in a manner similar to the SPM block 92. In one embodiment, only one of the SPM blocks 92 or 94 may be used (e.g., only the block 92). In another embodiment no SPM block 92 or 94 may be used.

The model implementation block 96 may receive, during a first period, a dependent variable Y representing a differential pressure AP across a cyclone and an independent variable X representing a set of process variables that may have some effect on the ΔP. As will be described in more detail below, the model implementation block 96 may generate a regression model using a plurality of data sets (X, Y) to model Y (e.g., the pressure difference ΔP) as a function of X (e.g., one or more independent variables affecting ΔP).

The model implementation block 96 may include one or more regression models, each of which may utilize a function to model the dependent variable Y as a function of the independent variable X over any range of X, over a specified range of X, and/or over multiple ranges of X. For example, it is possible that a single X-variable might be used to predict the Y-variable under all normal operating conditions. In this case, any known univariate regression method may be used. In another embodiment, different models may be developed for different ranges. For example, in an extensible regression approach, a regression model may be developed for multiple ranges of the independent variable X. This general approach is further described in U.S. application Ser. No. 11/492,467, which is hereby incorporated by reference herein.

In one embodiment, the regression model may include or use a linear regression model. Generally, a linear regression model uses some linear combination of functions f(X), g(X), h(X), etc. or, for modeling an industrial process, a typically adequate linear regression model may include a first order function of X (e.g., Y=m*X+b) or a second order function of X (e.g., Y=a*X²+b*X+c). Of course, other types of functions may be utilized as well, such as higher order polynomials, sinusoidal functions, logarithmic functions, exponential functions, power functions, etc.

After the model has been trained, the model implementation block 96 may be used to generate a predicted value (Y_{P}) of a dependent variable Y during a second period of operation based on a given independent variable X input. In the case of a fluid catalytic cracking unit, Y_{P} may represent a predicted differential pressure ΔP whereas Y may represent an actual or current measure of the differential pressure ΔP. The predicted ΔP (or Y_{P}) of the model implementation block 96 may be provided to a deviation detector 98. The deviation detector 98 may receive the predicted ΔP (or Y_{P}) of the regression model of the block 96 as well as the dependent variable input Y (representing an actual or current measure of ΔP). Generally speaking, the deviation detector 98 may compare the actual pressure differential ΔP to the predicted pressure differential ΔP to determine if the actual pressure differential ΔP is significantly deviating from the predicted pressure differential ΔP. If the actual pressure differential ΔP is significantly deviating from the predicted pressure differential ΔP, this may indicate that an abnormal situation catalyst loss has occurred, is occurring, or may occur in the near future. As a result, the deviation detector 98 may generate an indicator of the deviation. In some implementations, the indicator may be an alert or alarm indicating abnormal catalytic loss.

The difference between the actual pressure differential ΔP and the predicted pressure differential ΔP may be called a residual. The deviation detector 98 may be configured to generate an alarm only after a certain threshold residual value is reached or exceeded. Any of various known methods may be used to establish the threshold for detecting the abnormal catalytic loss condition. Similar to the SPM model described above, the threshold may be, for example, a certain percentage of the predicted Y-value, or it may be based on the variance of the residuals calculating using the training data. Also, any form of alarming logic (e.g., two or more consecutive observations exceeding a threshold) may be used prior to generating an alarm seen by plant personnel.

One of ordinary skill in the art will recognize that the AOD module 90 may be modified in various ways. For example, the process variable data may be filtered, trimmed, etc., prior to being received by the SPM blocks 92 and 94. In another embodiment the SPM blocks 92 and 94 may not be used. Additionally, although the model used in block 96 is illustrated as having a single independent variable input X, a single dependent variable input Y, and a single predicted value Y_{P}, the model in block 96 may include a regression model that models multiple variables Y (e.g., differential pressure across two or more cyclones) as a function of multiple variables X. The model in block 96 may comprise a multiple linear regression (MLR) model, a principal component regression (PCR) model, a partial least squares (PLS) model, a ridge regression (RR) model, a variable subset selection (VSS) model, a support vector machine (SVM) model, etc. In one embodiment two differential pressures may be modeled such as the differential pressure ΔP₁ over the reactor cyclone 20 and differential pressure ΔP₂ over regenerator cyclone 31. In this manner, the independent variable set X may represent process characteristics that effect both the differential pressure ΔP₁ over the reactor cyclone 20 and differential pressure ΔP₂ over regenerator cyclone 31.

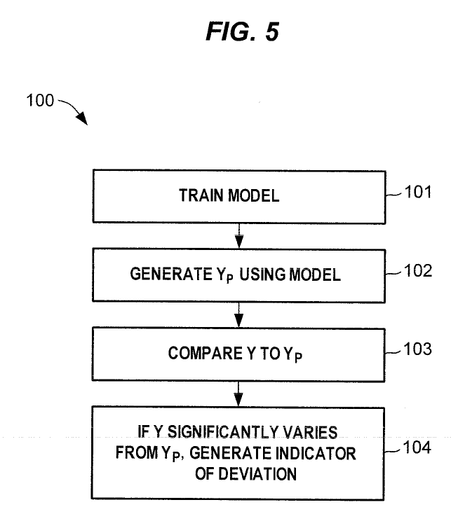

FIG. 5 illustrates a process flow diagram of an example method for detecting or predicting abnormal catalyst loss in a fluid catalytic cracking unit. The method 100 may be implemented using the example AOD module 90 of FIG. 4. At a block 101, a model implementation block, such as the model block 96, may be trained. For example, the model may be trained using independent variable X and dependent variable Y data sets to configure this model to predict Y as a function of X. The model may include, for example, multiple regression models that each model Y as a function of X for a different range of X.

Then, at a block 102, the trained model generates predicted values (Y_{P}) of the dependent variable Y using values of the independent variable X that it receives. Next, at a block 103, the actual values of Y are compared to the corresponding predicted values Y_{P} to determine if Y is significantly deviating from Y_{P}. For example, the deviation detector 98 may receive the output Y_{P} of the model block 96 and may compare the output Y_{P} to the dependent variable Y. If it is determined that Y has significantly deviated from Y_{P} an indicator of the deviation may be generated at a block 104. In the AOD module 90, for example, the deviation detector 98 may generate the indicator. The indicator may be an alert or alarm, for example, or any other type of signal, flag, message, etc., indicating that a significant deviation has been detected.

As will be discussed in more detail below, the block 101 may be repeated after the model has been initially trained and after it has generated predicted values Y_{P} of the dependent variable Y. For example, the model may be retrained if a set point in the process has been changed, or at other times during operation of the process.

### A Process Control System For Use With The AOD Modules

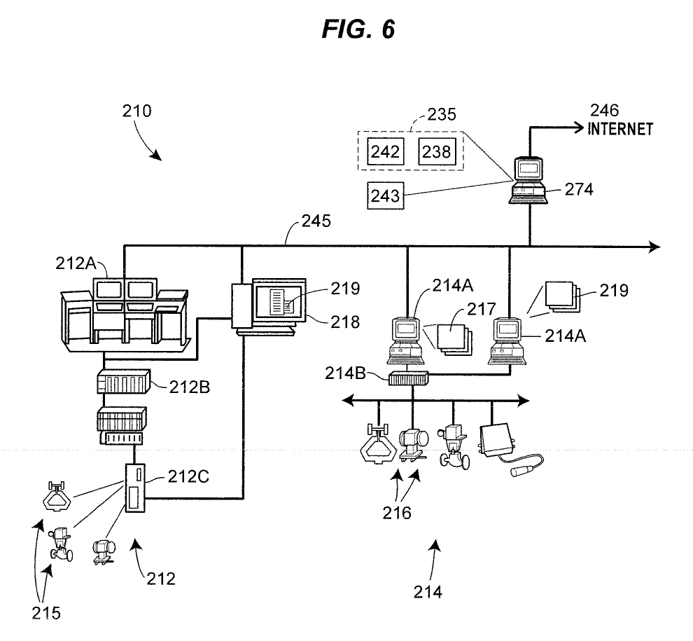

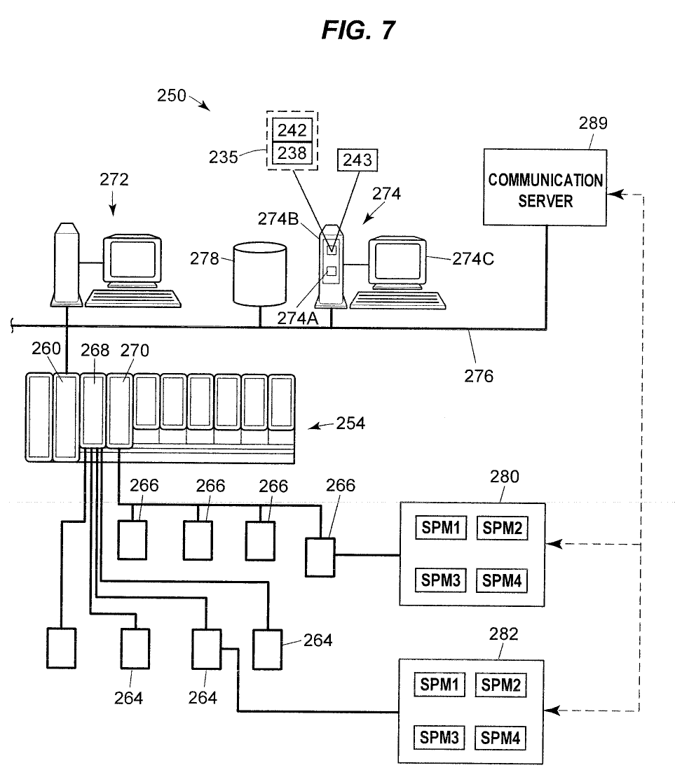

The fluid catalytic cracking unit may operate in a process plant as one part or piece of equipment of many sets of interconnected equipment, thereby forming a process line. Generally, this equipment may be controlled and managed using a process control system such as that illustrated in FIGS. 6 and 7.

Referring specifically to FIG. 6, an example process plant 210 in which an abnormal situation prevention system may be implemented includes a number of control and maintenance systems interconnected together with supporting equipment via one or more communication networks. In particular, the process plant 210 of FIG. 6 includes one or more process control systems 212 and 214. The process control system 212 may be a traditional process control system such as a PROVOX or an RS3 system or any other control system which includes an operator interface 212A coupled to a controller 212B and to input/output (PO) cards 212C which, in turn, are coupled to various field devices such as analog and Highway Addressable Remote Transmitter (HART) field devices 215. The process control system 214, which may be a distributed process control system, includes one or more operator interfaces 214A coupled to one or more distributed controllers 214B via a bus, such as an Ethernet bus. The controllers 214B may be, for example, DeltaV™ controllers sold by Emerson Process Management of Austin, Tex. or any other desired type of controllers. The controllers 214B are connected via P/O devices to one or more field devices 216, such as for example, HART or FOUNDATION® Fieldbus field devices or any other smart or non-smart field devices including, for example, those that use any of the PROFIBUS®, WORLDFIP®, Device-Net®, AS-Interface and CAN protocols. Generally, a process controller may communicate with a plant network system to provide information about operations under the process controller's management (e.g., field device operation) and to receive setpoint signals from the plant network system that are used in adjusting the operation of a process controller. As is known, the field devices 216 may control a physical process parameter (e.g., as an actuator) or may measure a physical process parameter (e.g., as a sensor). The field devices may communicate with the controllers 214B to receive a process control signal or to provide data on a physical process parameter. The communication may be made via analog or digital signals. I/O devices may receive messages from a field device for communication to a process controller or may receive messages from a process controller for a field device. The operator interfaces 214A may store and execute tools 217, 219 available to the process control operator for controlling the operation of the process including, for example, control optimizers, diagnostic experts, neural networks, tuners, etc.

Still further, maintenance systems may be connected to the process control systems 212 and 214 or to the individual devices therein to perform maintenance and monitoring activities. For example, a maintenance computer 218 may be connected to the controller 212B and/or to the devices 215 via any desired communication lines or networks (including wireless or handheld device networks) to communicate with and, in some instances, reconfigure or perform other maintenance activities on the devices 215. Similarly, maintenance applications may be installed in and executed by one or more of the user interfaces 214A associated with the distributed process control system 214 to perform maintenance and monitoring functions, including data collection related to the operating status of the devices 216.

As illustrated in FIG. 6, a computer system 274 may implement at least a portion of an abnormal situation prevention system 235, and in particular, the computer system 274 may store and implement a configuration application 238 and an abnormal operation detection system 242. Additionally, the computer system 274 may implement an alert/alarm application 243.

FIG. 7 illustrates a portion 250 of the example process plant 210 of FIG. 6 for the purpose of describing one manner in which the abnormal situation prevention system 235 and/or the alert/alarm application 243 may communicate with various devices in the portion 250 of the example process plant 210.

Generally speaking, the abnormal situation prevention system 235 may communicate with abnormal operation detection systems (not shown in FIG. 6) optionally located in the field devices 215, 216, the controllers 212B, 214B (shown in FIG. 7), and any other desired devices and equipment within the process plant 210, and/or the abnormal operation detection system 242 in the computer system 274, to configure each of these abnormal operation detection systems and to receive information regarding the operation of the devices or subsystems that they are monitoring. The abnormal situation prevention system 235 may be communicatively connected via a hardwired bus 245 to each of at least some of the computers or devices within the plant 210 or, alternatively, may be connected via any other desired communication connection including, for example, wireless connections, dedicated connections which use OPC, intermittent connections, such as ones which rely on handheld devices to collect data, etc. Likewise, the abnormal situation prevention system 235 may obtain data pertaining to the field devices and equipment within the process plant 210 via a LAN or a public connection, such as the Internet, a telephone connection, etc. (illustrated in FIG. 6 as an Internet connection 246) with such data being collected by, for example, a third party service provider. Further, the abnormal situation prevention system 235 may be communicatively coupled to computers/devices in the plant 210 via a variety of techniques and/or protocols including, for example, Ethernet, Modbus, HTML, XML, proprietary techniques/protocols, etc.

The portion 250 of the process plant 210 illustrated in FIG. 7 includes a distributed process control system 254 having one or more process controllers 260 connected to one or more field devices 264 and 266 via input/output (I/O) cards or devices 268 and 270, which may be any desired types of P/O devices conforming to any desired communication or controller protocol. The field devices 264 are illustrated as HART field devices and the field devices 266 are illustrated as FOUNDATIONS Fieldbus field devices, although these field devices may operate using any other desired communication protocols. Additionally, each of the field devices 264 and 266 may be any type of device such as, for example, a sensor, a valve, a transmitter, a positioner, etc., and may conform to any desired open, proprietary or other communication or programming protocol, it being understood that the I/O devices 268 and 270 must be compatible with the desired protocol used by the field devices 264 and 266.

In any event, one or more user interfaces or computers 272 and 274 (which may be any types of personal computers, workstations, etc.) accessible by plant personnel such as configuration engineers, process control operators, maintenance personnel, plant managers, supervisors, etc. may coupled to the process controllers 260 via a communication line or bus 276 which may be implemented using any desired hardwired or wireless communication structure, and using any desired or suitable communication protocol such as, for example, an Ethernet protocol. In addition, a database 278 may be connected to the communication bus 276 to operate as a data historian that collects and stores configuration information as well as on-line process variable data, parameter data, status data, and other data associated with the process controllers 260 and the field devices 264 and 266 within the process plant 250. Thus, the database 278 may operate as a configuration database to store the current configuration, including process configuration modules, as well as control configuration information for the process control system 254 as downloaded to and stored within the process controllers 260 and the field devices 264 and 266. Likewise, the database 278 may store historical abnormal situation prevention data, including statistical data (e.g., training data) collected by the field devices 264 and 266 within the process plant 210, statistical data determined from process variables collected by the field devices 264 and 266, and other types of data.

While the process controllers 260, P/O devices 268 and 270, and field devices 264 and 266 are typically located down within and distributed throughout the sometimes harsh plant environment, the workstations 272 and 274, and the database 278 are usually located in control rooms, maintenance rooms or other less harsh environments easily accessible by operators, maintenance personnel, etc.

Generally speaking, the process controllers 260 store and execute one or more controller applications that implement control strategies using a number of different, independently executed, control modules or blocks. The control modules may each be made up of what are commonly referred to as function blocks, wherein each function block is a part or a subroutine of an overall control routine and operates in conjunction with other function blocks (via communications called links) to implement process control loops within the process plant 210. As is well known, function blocks, which may be objects in an object-oriented programming protocol, typically perform one of an input function, such as that associated with a transmitter, a sensor or other process parameter measurement device, a control function, such as that associated with a control routine that performs PID, fuzzy logic, etc. control, or an output function, which controls the operation of some device, such as a valve, to perform some physical function within the process plant 250. Of course, hybrid and other types of complex function blocks exist, such as model predictive controllers (MPCs), optimizers, etc. It is to be understood that while the Fieldbus protocol and the DeltaV™ system protocol use control modules and function blocks designed and implemented in an object-oriented programming protocol, the control modules may be designed using any desired control programming scheme including, for example, sequential function blocks, ladder logic, etc., and are not limited to being designed using function blocks or any other particular programming technique.

As illustrated in FIG. 7, the maintenance workstation 274 includes a processor 274A, a memory 274B and a display device 274C. The memory 274B may store the abnormal situation prevention application 235 and the alert/alarm application 243 discussed with respect to FIG. 1 in a manner that these applications may be implemented on the processor 274A to provide information to a user via the display 274C (or any other display device, such as a printer).

Each of one or more of the field devices 264 and 266 may include a memory (not shown) for storing routines such as routines for implementing statistical data collection pertaining to one or more process variables sensed by sensing devices and/or routines for abnormal operation detection, which will be described below. Each of one or more of the field devices 264 and 266 may also include a processor (not shown) that executes routines such as routines for implementing statistical data collection and/or routines for abnormal operation detection. Statistical data collection and/or abnormal operation detection need not be implemented by software. Rather, one of ordinary skill in the art will recognize that such systems may be implemented by any combination of software, firmware, and/or hardware within one or more field devices and/or other devices.

As illustrated in FIG. 7, some (and potentially all) of the field devices 264 and 266 may include abnormal operation detection modules 280 and 282. While the blocks 280 and 282 of FIG. 7 are illustrated as being located in one of the devices 264 and in one of the devices 266, these or similar modules may be located in any number of the field devices 264 and 266, may be located in other devices, such as the controller 260, the I/O devices 268, 270 or any of the devices illustrated in FIG. 6. Additionally, the modules or blocks 280 and 282 may be in any subset of the devices 264 and 266.

Generally speaking, the blocks 280 and 282 or sub-elements of these blocks, collect data, such a process variable data, from the device in which they are located and/or from other devices. Additionally, the blocks 280 and 282 or sub-elements of these blocks may process the variable data and perform an analysis on the data for any number of reasons. In other words, the blocks 280 and 282 may represent AOD module 70 or 90 as described above. Consequently, the blocks 280 or 282 may include a set of one or more statistical process monitoring (SPM) blocks or units such as blocks SPM1-SPM4.

It is to be understood that while the blocks 280 and 282 are shown to include SPM blocks in FIG. 7, the SPM blocks may instead be stand-alone blocks separate from the blocks 280 and 282, and may be located in the same device as the corresponding block 280 or 282 or may be in a different device. The SPM blocks discussed herein may comprise known Foundation Fieldbus SPM blocks, or SPM blocks that have different or additional capabilities as compared with known Foundation Fieldbus SPM blocks. The term statistical process monitoring (SPM) block is used herein to refer to any type of block or element that collects data, such as process variable data, and performs some statistical processing on this data to determine a statistical measure, such as a mean, a standard deviation, etc. As a result, this term is intended to cover software, firmware, hardware and/or other elements that perform this function, whether these elements are in the form of function blocks, or other types of blocks, programs, routines or elements and whether or not these elements conform to the Foundation Fieldbus protocol, or some other protocol, such as Profibus, HART, CAN, etc. protocol. If desired, the underlying operation of blocks 250 may be performed or implemented at least partially as described in U.S. Pat. No. 6,017,143, which is hereby incorporated by reference.

It is to be understood that although the blocks 280 and 282 are shown to include SPM blocks in FIG. 7, SPM blocks capability is not required of the blocks 280 and 282. For example, abnormal operation detection routines of the blocks 280 and 282 may operate using process variable data not processed by an SPM block. As another example, the blocks 280 and 282 may each receive and operate on data provided by one or more SPM blocks located in other devices. As yet another example, the process variable data may be processed in a manner that is not provided by many typical SPM blocks. As just one example, the process variable data may be filtered by a finite impulse response (FIR) or infinite impulse response (IIR) filter such as a bandpass filter or some other type of filter. As another example, the process variable data may be trimmed so that it remained in a particular range. Of course, known SPM blocks may be modified to provide such different or additional processing capabilities.

The block 282 of FIG. 7, which is illustrated as being associated with a transmitter, may have a plugged line detection unit that analyzes the process variable data collected by the transmitter to determine if a line within the plant is plugged. In addition, the block 282 may include one or more SPM blocks or units such as blocks SPM1-SPM4 which may collect process variable or other data within the transmitter and perform one or more statistical calculations on the collected data to determine, for example, a mean, a median, a standard deviation, etc. of the collected data. While the blocks 280 and 282 are illustrated as including four SPM blocks each, the blocks 280 and 282 may have any other number of SPM blocks therein for collecting and determining statistical data.

### Implementing the AOD Modules

The AOD modules 70 and 90 of FIGS. 3 and 4, respectively, may be implemented in the process control system illustrated in FIGS. 6 and 7. For example, the AOD modules 70 and 90 may be implemented wholly or partially in a field device and the field device may then be coupled to either the reactor cyclone 20 or the regenerator cyclone 31, or both. For example, if the AOD module 90 is used, then the SPM blocks 92 and 94 of AOD module 90 may be implemented in the field device 266 while the model implementation block 96 and/or the deviation detector 98 may be implemented in a process controller 260, or a workstation 274 (e.g., via detection application 242) or some other device. Similarly, the process blocks of AOD module 70 may be wholly implement in a field device (e.g., 264 or 266) or divided among a field device and a process controller. In one particular implementation, the AOD system 70 or 90 may be implemented as a function block, such as a function block described above and used in a process control system that implements a FOUNDATION® Fieldbus protocol. Such a function block may or may not include the SPM blocks 92 and 94. In another implementation, at least one of the blocks of AOD 70 and 90 may be implemented as a function block.

Because catalyst loss may be detected using a differential pressure across the cyclones 20 and 31, any of the field devices described in FIG. 6 and 7 having a differential pressure sensor may be used to take measurements of the differential pressure. However, there may advantages to using a field device with built-in signal processing (e.g., a Rosemount 3051S with abnormal situation prevention). In particular, because a process control field device has access to data sampled at a much faster rate than a host system (e.g., a workstation collecting measurements from field devices via a process controller), statistical signatures calculated in the field device may be more accurate. As a result, AOD and SPM modules implemented in a field device are generally capable of determining better statistical calculations with respect to the collected process variable data than a block located outside of the device in which the process variable data is collected.

It should be noted that a Rosemount 3051 FOUNDATION® Fieldbus transmitter has an Advanced Diagnostics Block (ADB) with SPM capabilities. This SPM block may have the capability to learn a baseline mean and standard deviation of a process variable, compare the learned process variables against a current mean and standard deviation, and trigger a PlantWeb alert if either of these changes by more than the user-specified threshold. It is possible that the SPM functionality in the field device may be configured to operate as an AOD module (such as AOD module 70) based on the description herein to detect catalyst losses, provided that the differential pressure ΔP does not change as a result of the process moving into other normal operating regions.

The alert/alarm application 243 may be used to manage and/or route alerts created by the AOD modules 280 and 282, which may include AOD modules 70 and/or 90. In this case, when catalyst loss is detected, a meaningful alert may be provided to a person or group responsible for monitoring and maintaining operations (e.g., an operator, an engineer, a maintenance personnel, etc.). Guided help may be provided to help a person to resolve the situation through a user interface (e.g., on workstation 272 or 274 connected to the process control system). Corrective actions that may be presented to a user in response to the alert may include directions to a) increase pressure in regenerator; b) fix cyclones; and/or c) use heavier catalyst.

The AOD modules 70 or 90 may provide information to the abnormal situation prevention system 235 via alert application 243 and/or other systems in the process plant. For example, the deviation indicator generated by the deviation detector 98 or a calculation block 76 may be provided to the abnormal situation prevention system 235 and/or the alert/alarm application 243 to notify an operator of the abnormal condition. As another example, after the model of model implementation block 96 of AOD Module 90 has been trained, parameters of the model may be provided to the abnormal situation prevention system 235 and/or other systems in the process plant so that an operator can examine the model and/or so that the model parameters can be stored in a database. As yet another example, the AOD modules 70 or 90 may provide X, Y, and/or Y_{P} values to the abnormal situation prevention system 235 so that an operator may view the values (e.g., when a deviation has been detected).

In a process control system, the AOD module 70 or 90 (implemented via a field device or process controller) may be in communication with configuration application 238 to permit a user to configure the AOD modules 70 or 90. For instance, one or more of the blocks of module 70 or 90 may have user configurable parameters that may be modified via the configuration application 238.

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments may be implemented, using either current technology or technology developed after the filing date of this patent, which would still fall within the scope of the claims.

1. A method of detecting catalyst loss in a fluid catalytic cracker comprising:
measuring a differential pressure across a cyclone in a fluid catalytic cracker;
determining an initial mean differential pressure across the cyclone during a first period of operation of the fluid catalytic cracker;
monitoring a current mean differential pressure across the cyclone during a second period of operation of the fluid catalytic cracker; and
determining an abnormal catalyst loss event if the current mean differential pressure across the cyclone is lower than the initial mean differential pressure across the cyclone by more than a threshold.

2. The method of claim 1, comprising using a statistical process monitoring algorithm to determine the initial mean differential pressure across the cyclone.

3. The method of claim 2, comprising implementing a portion of the statistical process monitoring algorithm in at least one of a field device or a process controller.

4. The method of claim 2, comprising setting the threshold to a percentage of the initial mean differential pressure.

5. The method of claim 1, comprising using a statistical process monitoring algorithm to determine a standard deviation of the initial mean differential pressure across the cyclone and setting the threshold to a multiple of the standard deviation of the initial mean differential pressure.

6. A method of detecting catalyst loss in a fluid catalytic cracking unit comprising:
monitoring a differential pressure across a cyclone in a fluid catalytic cracker;
monitoring a set of process parameters that effect the differential pressure across the cyclone;
generating a regression model during a learning period based on the monitored differential pressure and a collected set of monitored process parameters affecting the differential pressure across the cyclone;
calculating a predicted differential pressure using the regression model;
determining an abnormal catalyst loss event if a current differential pressure across the cyclone is different than the predicted pressure differential across the cyclone by more than a threshold.

7. The method of claim 6, comprising generating the regression model using a univariate regression.

8. The method of claim 6, comprising generating the regression model using an extensible regression that provides multiple regression models for multiple ranges of the set of process parameters.

9. The method of claim 6, wherein at least a subset of the set of process parameters is statistical signature data calculated in a field device.

10. The method of claim 6, comprising measuring the differential pressure across at least one of a reactor cyclone or a regenerator cyclone of the fluid catalytic cracker.

11. A device for detecting abnormal catalyst loss in a fluid catalytic cracking unit comprising:
a set of sensors for periodically measuring a pressure differential across a cyclone in the fluid catalytic cracking unit;
a logic module that determines a set of statistical parameters of the periodically measured pressure differential over a period of time;
a rules module that stores a set of instructions;
a training module that stores a set of process parameters;
a calculation module that determines an abnormal catalyst loss event based on the set of instructions in the rules module and the set of process parameters in the training module, wherein the calculation module generates an indication when an abnormal catalyst loss event occurs.

12. The device of claim 11, wherein the logic module calculates a mean and a standard deviation of the pressure differential over a period of time.

13. The device of claim 11, wherein the training module contains a first baseline set of statistical parameters corresponding to the set of statistical parameters that are periodically measured, wherein the first baseline set of statistical parameters is determined during an initial learning period of the device.

14. The device of claim 13, wherein the calculation block determines an abnormal catalyst event when the measured pressure differential is greater than a mean pressure differential determined during the initial learning period.

15. The device of claim 13, comprising operating the fluid catalytic cracking unit under a first set of process parameters and a second set of process parameters and wherein the first set of baseline statistical parameters is determined during a learning period while the fluid catalytic cracking unit is operating under a first set of process parameters and a second set of baseline statistical parameters is determined during a learning period while the fluid catalytic cracking unit is operating under a second set of process parameters.

16. The device of claim 15, wherein the calculation block determines an abnormal catalyst event based on the first set of baseline statistical parameters when the fluid catalytic cracking unit is operating under the first set of process parameters and determines an abnormal catalyst event based on the second set of baseline statistical parameters when the fluid catalytic cracking unit is operating under the second set of process parameters.

17. A device for detecting abnormal catalyst loss in a fluid catalytic cracking unit comprising:
a first input for receiving data on a pressure differential across a cyclone in the fluid catalytic cracking unit;
a second input for receiving data on a set of process parameters affecting the pressure differential;
a model implementation unit for calculating a predicted pressure differential value based on the set of process parameters;
a deviation detector that compares the predicted pressure differential value to an actual pressure differential value and generates a signal when the difference between the predicted pressure differential value and the actual pressure differential value exceeds a threshold.

18. The device of claim 17, wherein the model uses a univariate regression.

19. The device of claim 17, wherein at least a subset of the set of process parameters is statistical signature data calculated in a field device.

20. The device of claim 17, wherein the differential pressure is measured across at least one of a reactor cyclone or a regenerator cyclone of the fluid catalytic cracker.

21. A system for detecting abnormal catalyst loss in a fluid catalytic cracking unit comprising:
a process control system including a workstation, a process controller, and a plurality of field devices, wherein the workstation, process controller, and the plurality of field devices are communicatively connected to each other;
a fluid catalytic cracking unit having a reactor cyclone and a regenerator cyclone, wherein at least one field device is adapted to measure a pressure differential across the reactor cyclone or the regenerator cyclone;
an abnormal operation detection device adapted to receive data on the measured pressure differential, to access a set of normal operating values for the pressure differential, and to generate an alert when a difference between a measured pressure differential and the set of normal operating values exceeds a threshold.

22. The system of claim 21, further comprising an alarm management device that is adapted to receive the alert from the abnormal operation device and to display an indication of a catalyst loss.

23. The system of claim 21, further comprising a configuration application running on the workstation that is adapted to communicate with the abnormal operation detection and provide the set of normal operating values.

24. The system of claim 21, wherein the abnormal operation detection device is implemented in one of the plurality of field devices or the process controller.

25. The system of claim 21, wherein the abnormal operation detection device calculates the set of normal operating values for the pressure differential during an initial training period using one of a statistical process monitoring algorithm or a regression algorithm.
